(19) United States
(12) Patent Application Publication
(10) Pub. No.: US 2009/0327369 A1
(43) Pub. Date: Dec. 31, 2009

(54) METHOD AND APPARATUS FOR MULTI-FORMAT DATA EXCHANGE

(76) Inventors: Anil Madhav Murching, Hillsboro, OR (US); Richard Donald Krull, Portland, OR (US); Niall Seamus Mc Donnell, Portland, OR (US)

Correspondence Address: Robert D. Shedd, Patent Operations;THOMSON Licensing LLC, P.O. Box 5312, Princeton, NJ, 08543-5312, US

(21) Appl. No.: 12/310,334

(22) PCT Filed: Aug. 28, 2007
(86) PCT No.: PCT/US2006/033690

§ 371 Date: Feb. 19, 2009

(51) Int. Cl. G06F 17/30

(52) U.S. Cl. 707/205; 707/E17.005

(57) ABSTRACT

Multi-format file transfer can be accomplished, without the need for storing files in each of a plurality of formats, by linking a plurality asset-containing first folders (16₁-16ₘ), each having a first format, to a plurality of virtual non-asset containing second folders (14₁-14ₙ) each having a second format. A client seeking an asset in a particular format does so by accessing one of the virtual second folders associated with the asset in the requested format. The access request to the second folder maps to a linked first folder containing the asset in a base format. The asset then undergoes conversion into the requested format. In this way, an FTP server (10) need only store assets in a base format.

### BACKGROUND ART

This invention relates to a technique for accessing information in one of a plurality of formats.

### BACKGROUND ART

A typical computer-based system stores data, some times referred to as an asset, in any of several different forms, such as a media object with video and/or audio, an electronic document such as a Microsoft Word file, an Adobe PDF file, or a static image. The transport of such assets across a network, such as an Ethernet fabric, from one computer system to another, or among multiple such systems, often occurs using the well known File Transfer Protocol or FTP. To that end a FTP server makes use of the TCP/IP protocol associated with the Internet to transfer files between or among computer systems.

Under some circumstances, the FTP server will need to store and/or retrieve assets having different formats. For example, a server might need to provide access to a document in raw ASCII text format, in PDF format, or in a Microsoft Word format, etc. To support such multiple formats, some computer systems store multiple copies of the same asset, one copy for each format. This approach needlessly wastes storage space.

Another approach to address the problem of accommodating multiple formats includes extending the ‘SITE’ command within FTP protocol, and adding custom sub-commands to enable identification of different file formats. This approach incurs the disadvantage that such custom commands remain specific to each vendor in the absence of standardization. A conflict will occur if two vendors use a sub-command of the same name to implement different functionalities. Moreover, end users will need to learn the commands and syntax for each vendor.

Another approach to facilitating multi-format file exchange requires the use of a particular suffix for asset name to denote a particular format. For example, if an FTP Server stores a document named ‘Form1’, the server can tell its clients of the availability of files named ‘Form1.pdf’, ‘Form1.txt’, ‘Form1.doc’ etc., where the suffix after the period denotes the corresponding format. This approach incurs the disadvantage that suffixes will not necessary handle all file format types. Further, certain format sub-types (such as Word 97) become difficult to handle using suffixes.

Yet another approach to facilitating multi-format file exchange makes use of custom extensions for asset names, and particularly, the use of escape characters not legally permitted as part of a file name. As an example, consider a server that stores a file, e.g., a movie, named “foobar”. A request in the form of “foobar?DVAES3” would tell the FTP Server that the client seeks the movie “foobar” in the format “DVAES3”. This approach requires modifying the server to recognize the illegal character for the purpose of delineating the file name from the format type. Moreover, this requires agreement among vendors regarding the character for separating the file name from the format type.

Thus, a need exists for a technique for file exchange that readily accommodates different file formats.

### BRIEF SUMMARY OF THE INVENTION

In accordance with the present principles, there is provided a method for enabling multi-format file access. The method commences by linking a first, asset-containing file having a first format, to at least one non-asset containing second file of a second format. In other words, a link exists between the first folder that contains data of a particular format, and a second virtual folder of a second format that contains no data, but serves as a link to the first folder. In response to a request to access the second file, the first file having the asset of interest in a particular format, gets accessed. The asset of the first file undergoes a conversion from the first format to the format of the requested second file for delivery to a client.

### BRIEF SUMMARY OF THE DRAWING

FIG. 1 depicts a file structure within an FTP server in accordance with the present principles.

### DETAILED DESCRIPTION

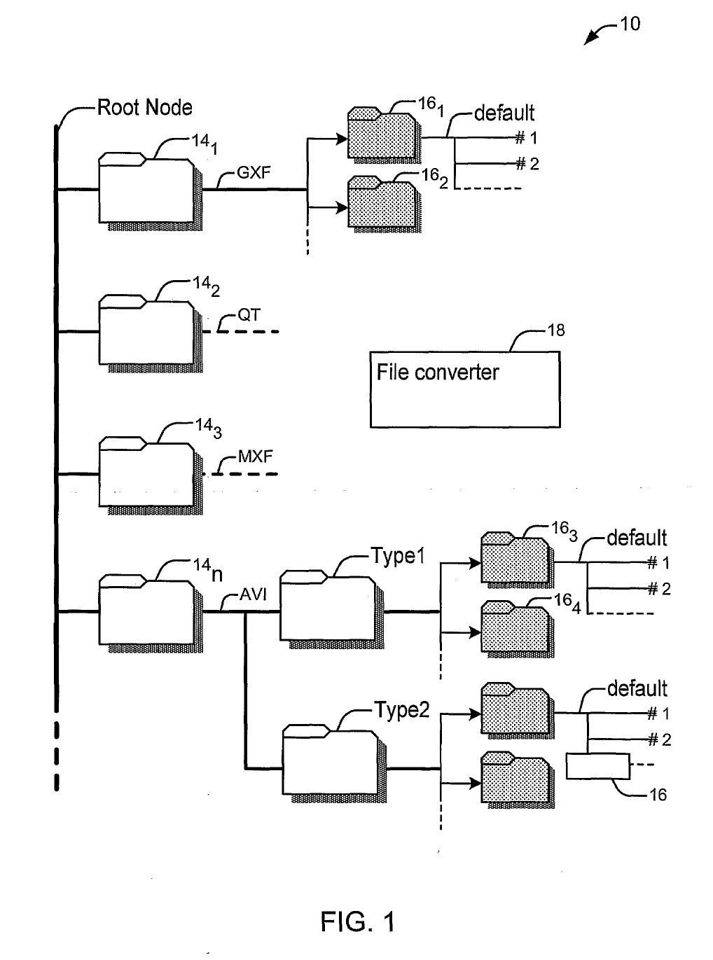

FIG. 1 depicts the file storage hierarchy within an FTP server 10 in accordance with the present principles. For ease of discussion, the file storage hierarchy within the FTP 10 will be described using terminology associated with a computer file system, although thought it should be understood that the file hierarchy of the present principles could easily find use in non-computer systems as well.

The file hierarchy in the FTP server 10 has a root node 12 which comprises the point of origin at which file requests arrive and at which files appear after being accessed from file folders linked to the root node. In accordance with the present principles, one or more virtual file folders, illustratively illustrated by virtual file folders 14₁-14ₙ exist at the root node 12, where n is an integer greater than zero. In other words, a file access request to read or write a file, once received at the root node 12, passes to one virtual file folders 14₁-14ₙ in accordance with identity of the file of interest.

The file folders 14₁-14ₙ bear the designation “virtual file folders” because they contain no assets. Stated another way, each of the virtual file folders has a unique identity, but stores no data. Rather, as discussed below, each of the virtual file folders 14₁14ₙ serves as a link to an asset-containing folder, such as one of asset-containing folders 16₁-16ₘ where m is an integer. Except for the fact that each of virtual file folders 14₁14ₙ contains no assets, the folders otherwise function in a conventional manner. In particular, each virtual file folder has a particular identity to permit a client to specify that folder for access.

In the illustrated embodiment depicted in FIG. 1, each of the virtual file folders 14₁-14ₙ has a label that identifies a particular asset, typically, a digital media file, (containing video, audio, etc.), as well as a particular format for that file. The file formats can include various supports media exchange formats such as GXF (SMPTE 360M), MXF (SMPTE 377M), QuickTime, AVI, Windows ASF, etc., allowing creation of virtual folders with the names “GXF”, “MXF”, “QT”, “AVI”, “ASF”. Other mnemonics could serve to capture the relevant aspects of a particular file format. Within the “AVI” folder, there can exist virtual sub-folders named “Type 1” and “Type 2”, corresponding to sub-categories of the AVI format.

The virtual file folders 14₁-14ₙ enjoy links to the asset-containing file folders 16₁-16ₘ such that every asset-containing file folder has a link to at least one virtual file folder. In the illustrated embodiment of FIG. 1, each asset containing file folder contains an asset, typically in the form of a digital media file in a base format, usually different than one of the usual media exchange formats such as GXF (SMPTE 360M), MXF (SMPTE 377M), QuickTime, AVI, Windows ASF. Each asset-containing file folders links to the corresponding virtual file folders that contain the name of that asset. Thus, for example, those virtual file folders having the names movie123/GXF, movie123/MXF and movie 123/QT, which identify the asset movie123 in each of the formats GXF, MXF and QT, respectively, each have a link to the asset containing file folder with the name movie123/baseformat. In other words all of the virtual file folders 14₁-14ₙ that identify the asset movie123 regardless of the particular format, link to the particular one of the asset-containing file folders 16₁-16ₘ containing the asset movie123 in the base format.

An access request received at the root node 12 of the FTP for the asset movie123 in a particular format, such as the GXF format for example, become associated with the particular one of the virtual folders 14₁-14ₙ identifying that asset in that format. That virtual file folder links to the corresponding one of the asset containing folders 16₁-16ₘ containing that asset in the base format. The asset within the asset-containing folder then undergoes a format conversion to the format associated with the linked virtual file via a file format converter 18. The converted file, which now exists in the desired format undergoes downloading to the client that made the access request.

As should be appreciated, an access request for a particular asset can appear at the FTP server 10 with a variety of aliases, each corresponding to a particular file format. Thus, a request for the asset movie123 can appear with any of the format identifiers asset with the file formats “GXF”, “MXF”, “QT”, “AVI”, “ASF”. When a client of the FTP server 10 of FIG, 1 seeks to retrieve the asset movie123, the knowledge of which alias (i.e., which file format) the client used to make request will determine the format of the asset sent to that client. For example, a client requesting the asset movie 123 in the MXF” will receive that asset in the MXF streaming format. The FTP Server 10 can choose to store the video, audio etc. data belonging associated with a particular asset in separate media files (one video file, 2 audio files—assuming stereo audio, etc.). Then, just before downloading to the requesting client, the FTP Server 10 can format the video and audio data in the desired format. Thus, in the case in which the client has requested the asset in the MXF format, the FTP server 10 can wrap the data in the MXF format. This formatting operation can occur ‘on-the-fly’. Using the file hierarchy described above, the FTP server 10 can advantageously send a particular asset to a client in any of the supported formats (AVI, GXF, QuickTime, etc.) without having to store that asset in each format.

The linkage between the virtual file folders 14₁-14ₙ and the asset containing folders 16₁-16ₘ allows the virtual file folders to effectively route a request for an asset in a particular format to the asset in a base format, and to enable conversion of that asset to the format specified in the request. The client making the request need not concern itself with the particular format in which the asset is actually stored. Rather the client need only specify the desired format of the asset for receipt following retrieval.

Similarly, if a client has data in a particular format, say GXF, for transmission to the FTP Server 10 then the client merely needs to specify the destination path (i.e., the virtual file folder), corresponding to the identity and file format type of the incoming asset. Upon receipt of that asset in the specified format at corresponding virtual file folder, the asset will then undergo conversion into a base or other format for storage in one associated one of the asset-containing folders 16₁-16ₘ. In this way, different clients having assets in different formats can all communicate with the FTP Server 10 without the need to undertake any data re-formatting on the client side. Of course, if the client erroneously tries to send, say, AVI data to a “/MXF/ . . . ” location, this operation will fail, and the client will receive a user-friendly error message indicative of such error.

The file hierarchy of the present principles permits the FTP Server 10 to selectively disable certain types of transfer protocols for certain assets. For example, suppose the FTP server 10 stores a certain asset “/HDClips/clip1” which contains high-definition video, together with audio. The FTP Server 10 can choose to not list this asset in the location/folder named “/AVI/HDClips/”. This has the effect that FTP clients will not be able to retrieve this asset in AVI format—they can only use GXF or MXF format, etc.

The above-described file hierarchy enjoys other advantages as well. As discussed, the file hierarchy eliminates the need to store multiple copies of the same asset. Clients of the FTP server 10 can use standard FTP protocol commands without any special modification to store or retrieve data in multiple formats. As new formats or sub-types of formats come into existence, or become supported, the FTP server 10 only has to add another virtual folder, thus obviating the need for additional command/syntax/client training. Further, the FTP Server 10 can selectively disable one or more formats for any given asset, by not listing that asset in its corresponding location. A client making a request in a non-available format will receive an error message.

Additionally, the file hierarchy of the present principles allows for easy customization of format nomenclature for individual clients. Suppose that a client has previously identified the MXF format as “SMPTE 377M”. Then, the FTP Server 10 would merely need to change the name of the virtual folder “/MXF/”. Not all FTP Server vendors will use the same convention as described herein so a customer that has servers from multiple vendors might find it necessary to customize their operations to each vendor type.

The foregoing describes a technique for accessing information in one of a plurality of formats.

1. A method for enabling multi-format file access, comprising the steps of:
linking a first, asset-containing file having a first format to at least one non-asset containing second file of a second format;
responsive to a request to access the second file, accessing the first file linked to the requested second file; and
converting the asset of the first file from the first format to the format of the requested second file for delivery.

2. The method according to claim 1 wherein the asset contained within the first file comprises one of: digital media, an electronic document or a static image.

3. The method according to claim 1 wherein the second format comprises one of the GXF, MXF, QuickTime, AVI, or Windows ASF formats.

4. The method according to claim 3 wherein the first format comprises a base format different than one of the GXF, MXF, QuickTime, AVI, or Windows ASF formats.

5. The method according to claim 1 further comprising the step of examining the request for access to determine whether the format of the requested second file constitutes an accessible format.

6. The method according to claim 1 5 further comprising the step of generating an alert message when the format of the requested second file does not constitutes an accessible format.

7. A method for enabling multi-format file access, comprising the steps of:
routing a request to access an asset in a first format to a file folder containing the asset in a second format
converting the asset in the file folder from the second format to the first format for delivery.

8. The method according to claim 7 wherein the asset contained within the file folder comprises one of: digital media, an electronic document or a static image.

9. The method according to claim 7 wherein the first format comprises one of GXF, MXF, QuickTime, AVI, or Windows ASF formats.

10. The method according to claim 9 wherein the second format comprises a base format different than one of the GXF, MXF, QuickTime, AVI, or Windows ASF formats.

11. The method according to claim 7 further comprising the step of examining the request for access to determine whether the first format constitutes an accessible format.

12. The method according to claim 11 further comprising the step of generating an alert message when the first format does not constitutes an accessible format.

13. An file server comprising:
a root node;
a first plurality of non-asset containing first file folders linked to the root node, each non-asset first file folder having a first format; and
a plurality of asset-containing second file folders, each having an asset of a second format and each second file folder linked to at least one first file folder to enable routing a request to access an asset in a first format to one of the second file folders containing the asset in a second format; and
means for converting the asset in the file folder from the second format to the first format for delivery.
